(19) United States
(12) Patent Application Publication
(10) Pub. No.: US 2005/0150747 A1
(43) Pub. Date: Jul. 14, 2005

(54) BELT TRACKING

(75) Inventors: Jorge Menendez, Barcelona (ES); Miguel Angel Ferrer, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/756,317

(22) Filed: Jan. 14, 2004

(51) Int. Cl. B65G 39/16

(52) U.S. Cl. 198/810.03; 198/807

(57) ABSTRACT

A belt-tracking apparatus for a printing device has a steering roller, a guiding roller and a continous belt encompassing them. A belt-steering mechanism is arranged to counteract a lateral belt movement by adjusting the distance between one end of the steering roller and. the corresponding end of the guiding roller by means of an actuator. The actuator is movably mounted on a base structure and arranged to rotate a threaded control rod having two differentially pitched threaded sections. The first and second sections cooperate with corresponding threads of a base structure and of said end of the steering roller, respectively, so that a rotation of the control rod shifts said end of the steering roller relative to the corresponding end of the guiding roller, and the actuator relative to the base structure.

### FIELD OF THE INVENTION

The present invention relates generally to belt tracking and, for example, to a belt-tracking apparatus and a method of counteracting a lateral drift of a conveying belt in a printing device.

### BACKGROUND OF THE INVENTION

In the field of printing devices conveying belts are common components. They are often used for carrying a recording material (or printing media, for example paper) and conveying it along a printing path. In such systems, the belt typically revolves around two or more rollers.

Lateral steering or centering of the belt on the rollers may be accomplished either actively or passively, for example by guides that limit lateral excursion or by crowning one or more of the rollers, which centers the belt. In another known passive steering system described in by U.S. Pat. No. 6,457,709 a tension mechanism biases the rollers apart to generate tension in the belt. The lateral belt shift is controlled by shifting one axis of a roller out of a common plane of the two roller axes which produces a slight change in the wrap angle between the belt and the roller and thereby creates a balancing counter force which re-centers the belt. An apparatus described in U.S. Pat. No. 5,248,027 is based on a similar technique; the angular position of a steering roller with respect to the printing plane is changed by a stepping motor and a cam which tilts one of the roller ends. The roller is mounted on a yoke which allows the tilting movement about an axis which is arranged perpendicularly to the roller's main axis and extends in the printing (conveying) direction. In both solutions the printing plane gets twisted out of its original orientation.

U.S. Pat. No. 6,141,525 discloses an arrangement for shifting a conveying belt in a lateral direction. One end of a roller is supported by a bearing which can be rotated around a vertical axis, perpendicularly to the conveying plane and the main axis of the corresponding roller. The opposite end of the roller is supported by a bearing which can be shifted in a horizontal direction (the conveying direction) by a pulse motor.

### SUMMARY OF THE INVENTION

The invention is directed to a belt-tracking apparatus for a printing device. It comprises a steering roller and a guiding roller, a continous belt encompassing the rollers, and a belt-steering mechanism arranged to counteract a lateral belt movement by adjusting the distance between one end of the steering roller and the corresponding end of the guiding roller by means of an actuator. The actuator is movably mounted on a base structure and arranged to rotate a threaded control rod having two differentially pitched threaded sections. The first section cooperates with a corresponding thread of the base structure, and the second section cooperates with a corresponding thread of said end of the steering roller, so that a rotation of the control rod shifts said end of the steering roller relative to the corresponding end of the guiding roller, and the actuator relative to the base structure.

According to another aspect, a belt-tracking apparatus is provided arranged to counteract a lateral drift of a conveying belt in a printing device. It comprises an adjustable belt tensioner arranged to apply variable tension to one side of the belt, an actuator arranged to adjust the belt tensioner, a sensor arrangement arranged to observe the belt's lateral position, and a controller. The controller is arranged, in response to a detection of a change of the belt's lateral position, to adjust the tensioner by an initial amount in an initial direction by means of the actuator, and to iteratively carry out the following activity, as long as changes of the belt's lateral position are detected: in response to a detection of a continued change of the belt's lateral position, further adjusting the tensioner in the same direction, or else, in response to a detection of a reversed change of the belt's lateral position, adjusting the tensioner in the other direction, wherein the amount of adjustment in the same or other direction is smaller than the previous amount of adjustment.

According to another aspect, a method is provided of counteracting a lateral drift of a conveying belt in a printing device by means an adjustable belt tensioner applying variable tension to one side of the belt. The method comprises observing the belt's lateral position, in response to a detection of a change of the belt's lateral position, adjusting the tensioner by an initial amount in an initial direction, and iteratively carrying out the following activity, as long as changes of the belt's lateral position are detected: in response to a detection of a continued change of the belt's lateral position, further adjusting the tensioner in the same direction, or else, in response to a detection of a reversed change of the belt's lateral position, adjusting the tensioner in the other direction, wherein the amount of adjustment in the same or other direction is smaller than the previous amount of adjustment.

Other features are inherent in the products and methods disclosed or will become apparent to those skilled in the art from the following detailed description of the embodiments and the accompanying drawings.

### DESCRIPTION OF THE DRAWINGS

Embodiments of the invention will now be described, by way of example, and with reference to the accompanying drawings, in which:

FIG. 1 shows a partial perspective view of a printing device including a belt-tracking apparatus;

FIG. 2 shows a side view of the device of FIG. 1;

FIG. 3 shows a schematic top view of the printing device of FIGS. 1 and 2, with some additional functional components;

FIG. 4 illustrates a method of counteracting lateral-belt drifts by means of an iterative search of a belt-tension-balance point;

FIG. 5 is a flow chart of a belt-tracking procedure including the iterative-balance-point search of FIG. 4.

### DESCRIPTION OF THE PREFERRED EMBODIMENTS

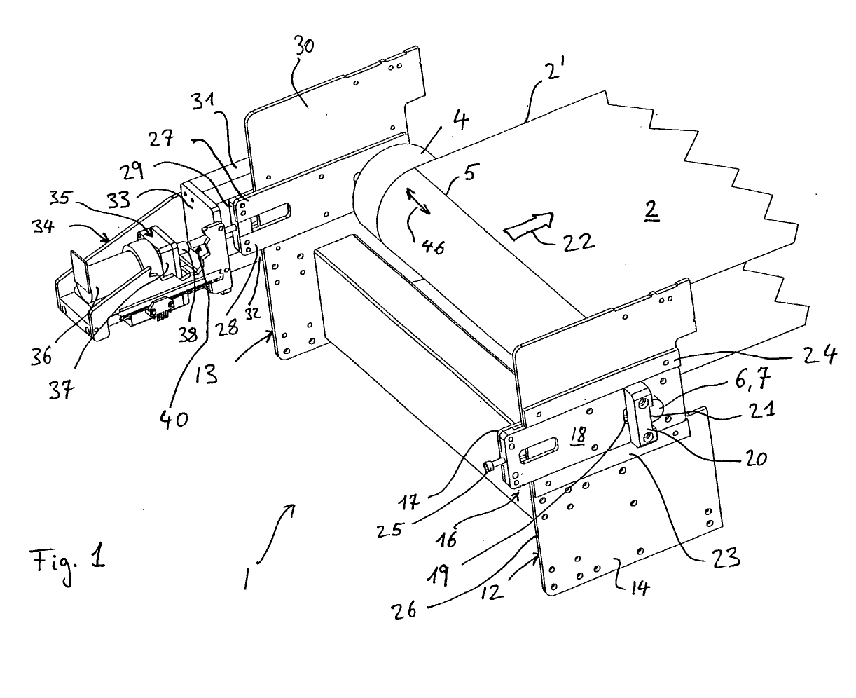

FIG. 1 shows a partial perspective view of a printing device including a belt-tracking apparatus. Prior to the detailed description of FIG. 1, a few items of the embodiments will be discussed.

In the embodiments, the printing device, e.g. an ink-jet printer, is equipped with a conveying belt to convey the printing media past consecutively arranged image-forming devices, e.g. page-wide arrays of ink-jet nozzles which extend across the belt. In order to achieve high image quality, partial images printed by the image-forming devices spaced along the belt are printed onto one another in an aligned manner, they are “registered”. A typical alignment tolerance is 50 microns. Partial images are, for example, color images of the total multicolor image, or parts of such single-color images in the case of redundant image-forming devices. Since the different image forming devices print their partial images consecutively at different places along the belt, a lateral movement of the belt during printing may cause a misalignment of partial images printed onto one another, which may degrade image quality. The embodiments of the printing device are therefore equipped with a belt-steering mechanism to counteract lateral belt movements.

In order to counteract lateral belt movements, two generally parallel belt rollers are adjusted such that they may slightly deviate from parallelism when viewed perpendicularly to the printing plane (by contrast, when viewed in the conveying (or longitudinal) direction, the rollers are always maintained in a parallel relationship, which keeps the distance between the printing media and the image forming devices constant). Such an adjustment would even be made if the two rollers could be manufactured in a perfectly parallel arrangement and a perfect belt could be produced, since the geometry and elastic properties of the roller arrangement and the belt will generally change due to temperature and humidity changes (including local humidity changes caused by the printing) and aging without counteraction, since these changes might cause lateral belt movements significant enough to degrade image quality.

In some of the embodiments this adjustment is achieved by operating a control rod with two differentially pitched threaded sections cooperating with two corresponding threads. The first threaded section cooperates with a thread fixed with respect to a base structure supporting the rollers. The second threaded section cooperates with a thread fixed with respect to an adjustable end of the shaft of the adjustable roller (called “steering end” and “steering roller”). Thus, the control rod defines the position of the steering end with respect to the base structure. When the control rod is rotated, the steering end is moved with respect to the support structure in the direction of the control rod.

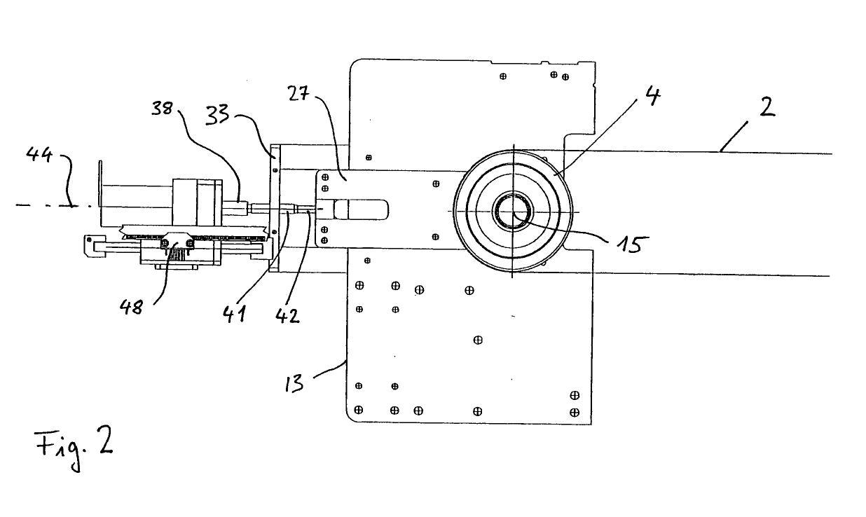

The feed of the steering end per rotation of the control rod relative to the base structure is determined by the thread pitches. In the embodiments, the threaded sections have the same direction of rotation (e.g. they are both right or left-handed). The feed per rotation is determined by the difference between the pitches of the two threaded sections, as will become clear from the detailed description of FIG. 2. This “differential” adjustment results in relatively small “effective pitch”, and thus enables the steering roller to be adjusted in a very precise manner. The linear movement of the control rod with respect to the base structure is indicative of the steering end's movement in an amplified manner; therefore, detection of this linear movement (e.g. by a linear encoder) is an amplified measurement of the steering end's linear movement.

For example, if the first threaded section (cooperating with the base structure) has a pitch of 1.25 mm (0.0492 inches) per revolution and the second threaded section has a pitch of 1.0 mm (0.0394 inches) per revolution, the resulting movement of the steering shaft end caused by one revolution of the control rod is 0.25 mm (0.0098 inches) with respect to the base structure. By contrast, the control rod and the actuator are moved by 1.25 mm (0.0492 inches) with respect to the base structure, corresponding to an amplification of five.

In some of the embodiments, the actuator comprises an electric drive and a gear. The gear interconnects the electric drive with the control rod. It is, for example, a gear reduction for gearing down the electric drive's original number of revolutions.

As already mentioned above, in some embodiments, the linear movement of the control rod itself (or the actuator attached to it) is detected by a measuring device, such as a linear encoder. The measured position of the control rod or the actuator is not only indicative of the position of the roller and in an amplified manner, but it also enables the measurement of this position to be performed without clearance. This is because both threaded sections are always biased in the same direction due to the belt tension.

Since the embodiments enable very small adjustments of the steering roller to be made, they are also suitable for use with high-strength belts. Hence, in some of the embodiments, belts made of metal (e.g. a steel sheet) are used.

In some of the embodiments, the belt is perforated, and its inner side is connected to a vacuum source to suck a printing media onto the belt.

In the embodiments a sensor arrangement is also provided to sense lateral belt displacements and generate displacement signals indicative of it. For example, the sensor arrangement may be arranged in the vicinity of one of the belt edges, and may be sensitive to the position of the belt edge. In some of the embodiments, the sensor arrangement comprises at least two sensors, e.g. four sensors, such as opto-electronical sensors arranged in a direction perpendicular to the belt edge. Each sensor is responsive to being covered by the belt. The sensors are arranged at the belt edge, so that one (or several) of them is (are) normally covered by the belt, and the other one (or the others) is (are) normally not covered. Signals indicative of a sensor being covered, or not, represent “belt displacement signals”. To increase the resolution, the sensors can be arranged in a staggered manner. In the embodiments, a controller is also provided to control the actuator based on the belt displacement signals. As will be explained below, in some of the embodiments the controller is a digital feedback controller having mainly differentiating characteristics, or a combination of differentiating and proportional and/or integral characteristics. With purely differentiating characteristics, the controller tries to stop a lateral drift of the belt, but does not bring the belt back to its normal center position during the printing process. If there are also proportional (and/or integrating) characteristics, the belt is brought back, however, with a low lateral-movement rate, since a fast return to the belt's normal center position might be a movement that has a degrading effect the image quality itself.

In some of the embodiments, the controller counteracts an observed lateral belt drift in an iterative manner. First, in response to a detection of a change of the belt's lateral position, a tensioner is adjusted by an initial amount in an initial direction which counteracts the observed lateral drift. However, since by this initial adjustment the “balance point” (i.e. an adjustment position in which the belt is not subject to a lateral drift) will be reached, the following activity is iteratively carried out, as long as changes of the belt's lateral position are detected. If a continued change of the belt's lateral position is detected, then the tensioner is further adjusted in the same direction, on the other hand, if a change of the belt's lateral position in the reverse direction is detected, the tensioner is further adjusted in the other direction; in both alternatives, the amount of adjustment (be it in the same or the other direction) is smaller than the previous amount of adjustment. Consequently, the balance point is reached by a series of adjustments with diminishing magnitude. In some of the embodiments, the amount of adjustment is halved from one iteration to the next. In these embodiments, the search for the balance point is a sort of binary search.

Although the initial amount of adjustment may be a fixed (e.g. pre-selected) value, or may depend on the observed lateral-belt displacement (expressed in millimeters or inches), in some of the embodiments the initial amount of adjustment depends on the detected rate of lateral-position change. For example, the rate may be determined as the ratio of the detected lateral displacement (in millimeters or inches) and the number of belt cycles which were needed for this displacement to occur. For example, if, in one case, a belt needs 20 cycles to exhibit a lateral displacement of 0.1 mm (0.0098 inches), and, in a second case, needs only ten cycles to exhibit the same displacement, the rate is twice as high in the second case as in the first case. Since a higher change of tension is required to stop a drift at such a higher rate, the higher the rate is the higher is the initial amount of adjustment applied.

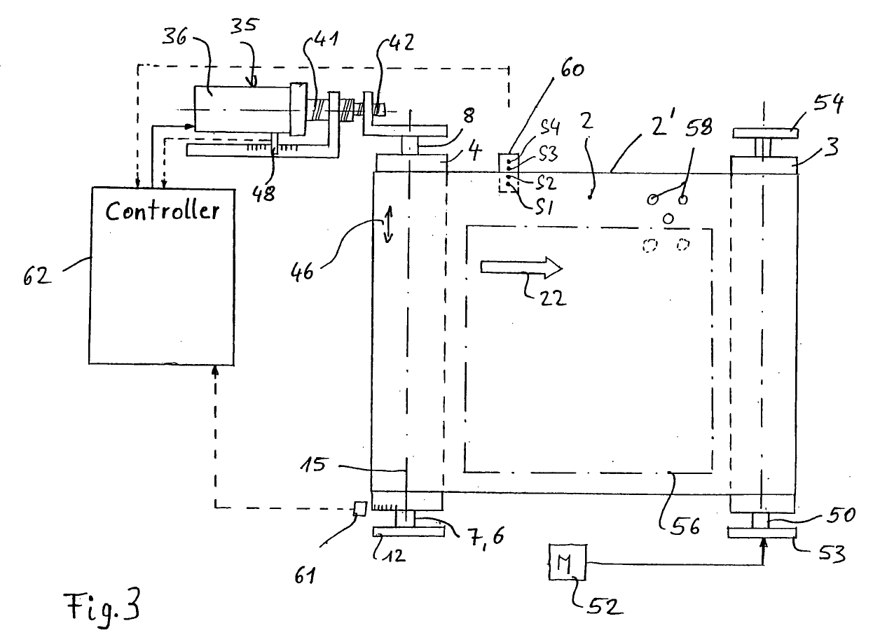

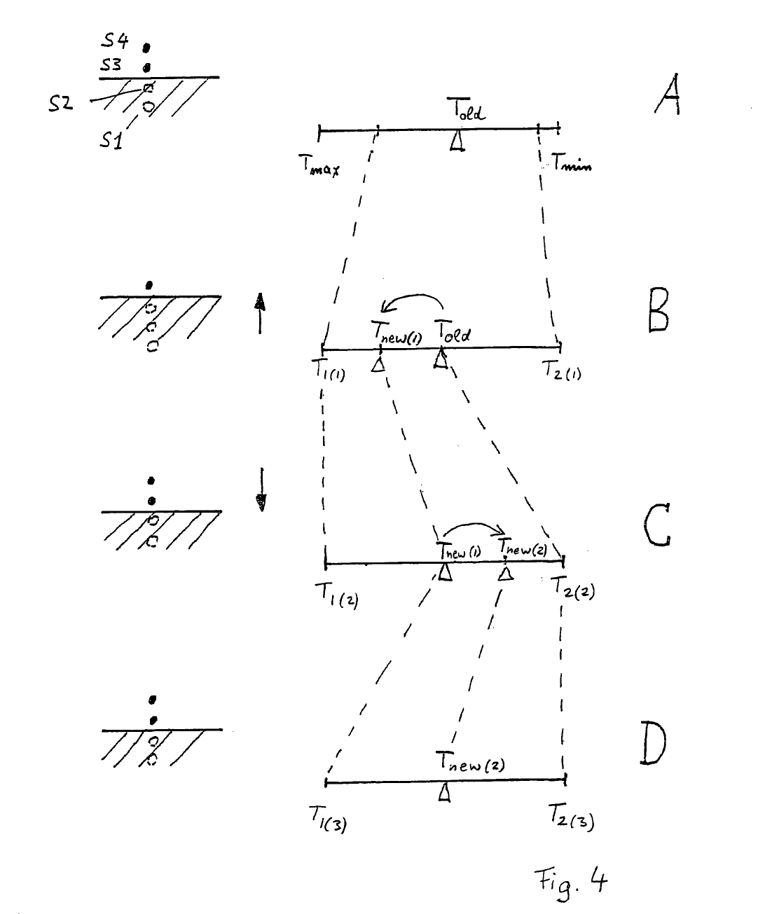

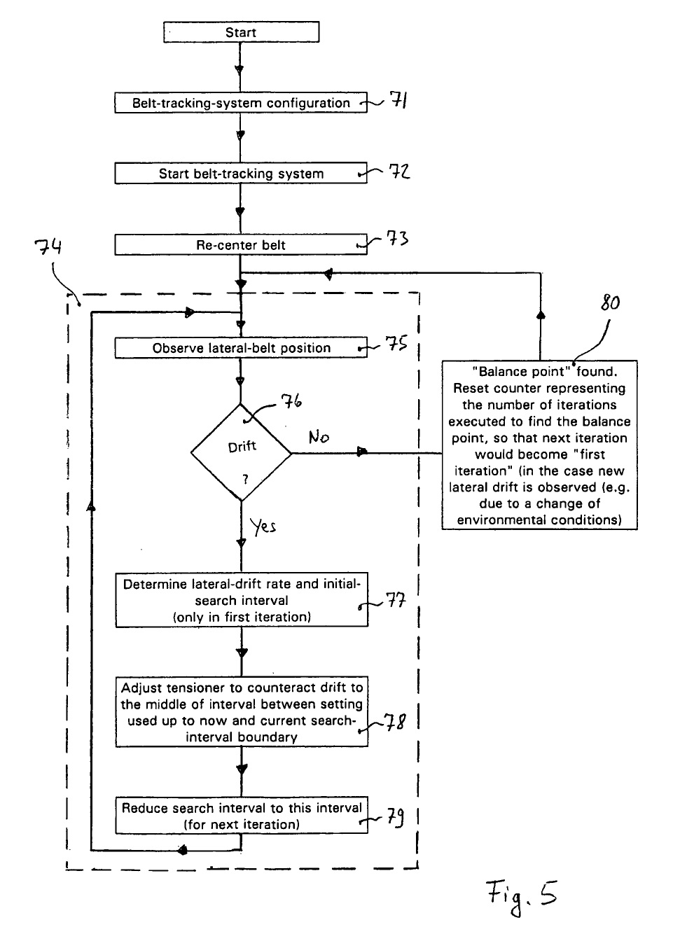

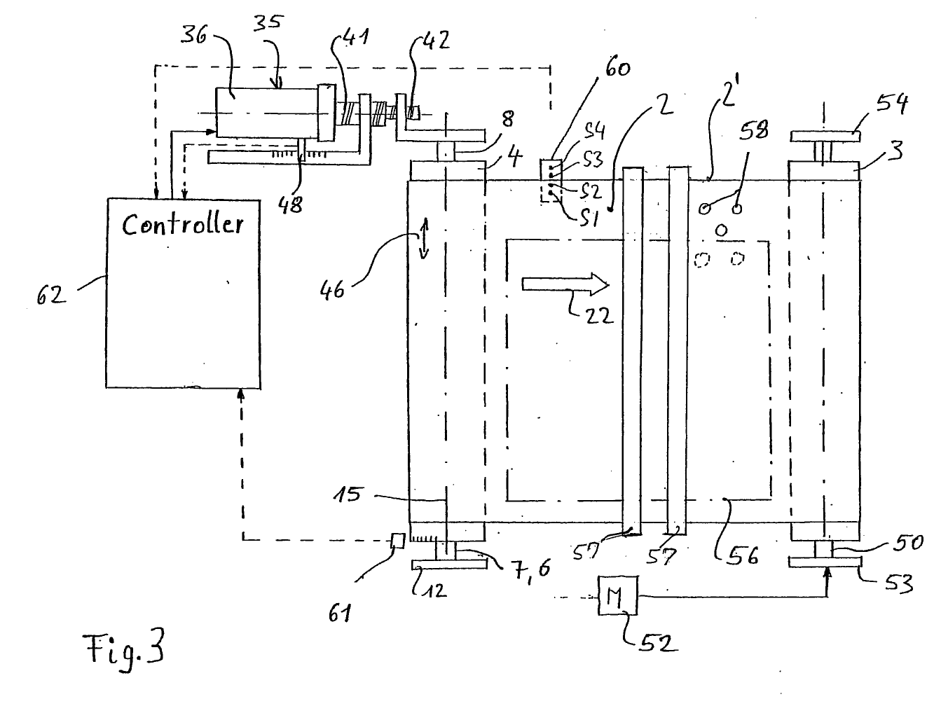

Returning now to FIG. 1, it shows the belt-tracking section of a printing device 1. An endless conveying belt 2 encompasses a steering roller 4 and a guiding roller 3 (FIG. 3). The conveying belt 2 is manufactured from a metal strip (e.g. stainless steel), with its ends being connected by a seam 5 to form an endless loop. The steering roller 4 is rotatably mounted on a shaft 6 with its ends 7, 8 (FIG. 3) extending from the corresponding ends of the steering roller 4. The steering roller 4 is mounted to the shaft by means of bearings which allow free rotation of the roller 4 on the shaft 6.

The shaft ends 7, 8 are supported by slotted links 12, 13 which are part of a base structure of the printing device 1. The slotted links 12, 13 are formed by plate members 14, 30 arranged perpendicularly to the shaft axis 15 (FIG. 3). The plate members 14, 30 have a recess. Shaft ends 7, 8 are carried by slide members 16, 27 each having two slide elements 17, 18; 28, 29 which extend on either side of the respective plate member 14, 30 with their inner faces abutting their plate members' outer faces. Each of the slide elements 17, 18; 28, 29 has a recess 19. The shaft ends 7, 8 extend through the respective plate member's recess and slide member's recesses 19, which are thereby aligned. The shaft ends 7, 8 are fixed with respect to the slide members 16, 27 by a lock bar 20 engaging the shaft ends 7, 8 with a flattening 21. The lock bar 20 is fixed to the outer slide element 18, 29, thereby fixing the shaft end torque-proof with respect to the slide members 16, 27. The slide members 16, 27 are guided parallel to the conveying direction 22 of the belt 2 (also called longitudinal direction) by guiding rails 23, 24; 31, 32. This arrangement enables the shaft ends 7, 8 to be moved in the conveying direction 22 of the belt 2, thereby enabling the belt tension to be independently adjusted at the two shaft ends 7, 8. At the shaft end 7, the tension can be manually adjusted (which is typically only done after set-up, but not during normal printing operation), whereas at the “steering end” 8 the tension can be automatically adjusted by an actuator (which is normally done during the printing operation to counteract lateral belt movements).

Both the manual and the automatic adjustments are performed by means of bolt members which engage the slide member 16, 27 by corresponding threads in the longitudinal direction 22. The ends of the bolt members abut against the front faces 26 of the plate members 14, 30. The shaft ends 7, 8 can be individually moved under the tension of the belt 2, by tightening or loosening the respective bolt member, thereby enabling an adjustment of the angular orientation of the steering roller 4 relative to the guiding roller 3 (which may be fixed or manually adjustable ). At the shaft end 7, the bolt member is a set screw 25 adjustable only manually; at the steering end 8 it is a driven control rod 40, which is explained in more detail in connection with FIG. 2.

At the steering end 8, the slide member 27 is also called “tensioner 27”. The guiding rails 31, 32 extend beyond the front face 26 to support a positioning flange 33; hence, they are also called “connection bars 31, 32”. The positioning flange 33 is fixed to the front ends of the connection bars 31, 32 perpendicularly to the longitudinal direction 22. The positioning flange 33 and the actuator support 34 are part of the printing device's base structure and are fixed relative to it. The actuator 35, however, is slidably supported by the actuator support 34 in a linear guide, and is thus movable relative to the base structure, as will be explained in more detail below.

The actuator 35 has, for example, a rotary electric drive motor 36 and a gear box 37 having a protruding drive shaft 38 connected to the control rod 40 which engages the positioning flange 33 and the tensioner 27.

The automatic-adjustment mechanism is now explained in more detail with regard to FIG. 2. The control rod 40 has two differentially pitched threaded sections 41, 42 cooperating with complementary threads in the positioning flange 33 and the tensioner 27. Both threaded sections 41, 42 have the same direction of orientation, but the pitch of them is different. In some embodiments the pitch of the first section 41 is higher (e.g. 1.25 mm (0.0492 inches) per revolution) than that of the second section 42 (e.g. 1.0 mm (0.0394 inches) per revolution); in other embodiments it is the other way round. Drive shaft 38, control rod 40 and the corresponding threads in the positioning flange 33 and the tensioner 27 are arranged along a common tensioning axis 44 extending in the longitudinal direction 22 and intersecting the shaft axis 15 perpendicularly.

In operation, the drive motor 36 rotates the drive shaft 38 via the gear box 37, and thereby the control rod 40. For example, it is assumed that the control rod 40 has right-handed threads and the drive shaft rotates clockwise (viewed in the direction from the drive motor 36 to the position flange 33). The first threaded section 41 is then screwed into the positioning flange 33, and the second threaded section 42 is screwed into the tensioner 27. The tensioner 27 is only moved relative to the base structure by the difference between the two pitches. Further assuming that the pitch of the first threaded section 41 is higher (e.g. 1.25 mm (0.0492 inches) per revolution) than that of the second threaded section 42 (e.g. 1.0 mm (0.0394 inches) per revolution), the tensioner 27 is moved by the difference of the two pitches (in the example above: 0.25 mm (0.0098 inches) per revolution) towards the guiding roller 3 (FIG. 3). If the pitch of the second section 42 is higher than that of the first section 41, the tensioner is still moved by the pitch difference, but now in the other direction, away from the guiding roller 3. This movement is transmitted by the tensioner 27 to the steering end 8 and thereby causes the belt tension to be either increased or decreased at the corresponding belt edge 2′ (FIG. 1), depending on the particular choice of pitches and the control rod's direction of rotation. This causes the belt 2 to move laterally along the rollers 3, 4 as indicated by arrow 46. This adjustment is used to counteract lateral drifts of the belt 2 caused by external influences (temperature and humidity changes, aging, etc.).

The whole actuator 35 is moved relative to the actuator support 34 by a distance depending on the pitch of the first section 41 when the control rod 40 is rotated. In the example above, the actuator 35 is displaced by 1.25 mm (0.0492 inches) per revolution towards the positioning flange 33. For the purpose of sensing this displacement, the actuator 35 is equipped with a measuring device 48, for example a linear encoder incrementally counting equally-spaced encoder marks arranged at the actuator support 34. The measured displacement of the actuator 35 represents, in an amplified manner, a measurement of the steering end's position with respect to the base structure. The amplification factor is the ratio of the pitch of the first section 41and the difference between the first and second sections'pitches. In the example above, the amplification factor is therefore “Five” (i.e. 5 length units are measured when the steering end 8 is moved by 1 length unit). The “algebraic sign” of the amplification factor depends on whether the pitch of the first section 41 is the larger one (then it is positive), or the one of the second section 42 (then it is negative). Some of the embodiments are equipped with a follow-up control requiring that the actuator 35 performs a certain displacement of the steering end 8. The above-described amplified measurement of the actual displacement of the steering end 8 based on the measured actuator's displacement is used as an input to this follow-up control. In turn, the follow-up control may be part of a feedback control to counteract lateral belt drifts during the printing operation, as described below.

FIG. 3 shows a schematic top view of the printing device 1. In addition to the partial views of FIGS. 1 and 2, it also shows the guiding roller 3 which is arranged on a shaft 50 and driven by a belt drive motor 52. The shaft 50 is arranged parallel to the shaft 6 and manually adjustably mounted to support members 53, 54 which are fixed with respect to the base structure. The belt 2 encompasses both rollers 3 and 4 and presents, between the rollers 3, 4, a plane printing region through which it conveys a printing media 56, for example past page-wide inkjet print arrays extending perpendicularly across the belt 2. Holes 58 are provided in the belt 2 connected to a vacuum source to suck the printing media 56 onto the belt 2. In the vicinity of the belt edge 2′, a sensor arrangement 60 is arranged to detect the lateral position of the belt edge 2′. It is a linear array of individual sensors, for example four sensors, S1, S2, S3, S4 oriented perpendicular to the longitudinal direction 22. Some of the sensors (e.g. S1, S2) are normally covered by the belt 2; others (e.g. S3, S4) are normally not covered by it. The sensors are, for example, opto-electronic sensors providing a signal indicative of whether the sensor is covered or not. The combined signal of the individual sensors is hence a digital representation of the belt's current lateral position, with an accuracy defined by the distance between two adjacent sensors. Furthermore, an encoder 61 is provided to generate a belt-conveying signal indicative of the belt movement in the conveying direction 22. A controller 62 is arranged to control (counteract) lateral belt displacements the during printing operation. For this purpose, it receives the signals from the sensor arrangement 60, the measuring device 48, and the belt-conveying encoder 61, and computes from these an actuating signal to cause the actuator 35 to counteract detected lateral belt drifts.

A lateral belt drift is detected by a change of the signal of the sensor arrangement 60. For example, if the belt drifts upwardly in FIG. 3, sensor S3 will also be covered by the belt 2, causing a corresponding change of the sensor arrangement's output signal. Thereupon, the controller 62 generates an actuating signal causing the actuator 35 to stop this drift and, in some embodiments, bring the belt back to its original position. In the example mentioned above, the actuator 35 would increase the tension of the belt edge 2′ to achieve this. In some embodiments the belt-conveying signal from the encoder 61 is also used; relating this signal to the lateral-displacement signal from the sensor arrangement 60 provides information about the lateral-drift rate (e.g. the amount of drift related to the number of belt cycles during which it occurred). In some of the embodiments, the amount of counteraction depends on the lateral-drift rate observed in this way, i.e. the higher the observed drift rate is, the higher is the counteracting change of the belt tension at belt edge 2′.

FIG. 4 illustrates an embodiment of a control method in which the balance point is found in an iterative search procedure. “Balance point” is to be understood as the setting of the adjustment mechanism in which the belt exhibits no lateral drift; “finding” the balance point means adjusting (i.e. manipulating) the adjustment mechanism in such a manner that a detected lateral drift is eliminated (or at least significantly diminished). Four different consecutive instances A, B, C, D are shown in FIG. 4, wherein the left-hand side illustrates the belt edge's lateral position relative to a sensor arrangement, e.g. the sensor arrangement 60 of FIG. 3 with sensors S1 to S4, and the right-hand side illustrates single-side-tension adjustments performed in response to the observed lateral-belt drifts. The first instance A represents the case of a stable condition without lateral-belt drift. This means that the belt edge 2′ (FIG. 3) of the running belt 2 remains stable in its given lateral position, for example between the sensors S2 and S3 in FIG. 4, hence, sensors S1 and S2 are covered. It is assumed that a certain position of the steering end 8 (FIG. 3) with the tensioner 27 (FIG. 1) corresponds to this condition, indicated by a triangle denoted by “T_{old}” in FIG. 4. On the right-hand side of situation A, the maximum-adjustment range is also indicated; it lies between Tₘₐₓ and Tₘᵢₙ.

It is now assumed that a lateral-belt drift occurs, for example due to a temperature change. This is illustrated by an upward arrow at B in FIG. 4. In the top view of FIG. 4, the belt moves upwardly, so that, after some time, it will also cover sensor S3. Typically, the sensor's state will not suddenly change from not covered to completely covered; rather, since the belt's edge 2′ is not an absolutely straight line in practice, the sensor S3 will first start to “blink” and will continue blinking for a certain number of belt cycles, until it is completely covered by the belt 2, as shown at B.

In response to the detected belt drift, the controller 62 (FIG. 3) now performs a procedure to counteract the drift by changing the tension at one side of the belt. The aim of this procedure is to find the new balance point of the steering end which corresponds to the new condition which has occurred after A. First, an initial “search interval” for the new balance point is defined, the limits of which are denoted by T₁₍₁₎ and T₂₍₁₎ in FIG. 4. It is an estimate of the range of possible tensioner settings within which the (not yet known) new balance point is expected to be. As shown in FIG. 4 at A, the initial-search interval is, of course, within the maximum adjustment range Tₘₐₓ to Tₘᵢₙ. The length of the initial-search interval may be a predefined value; however, if information about the drift rate is available, it may be chosen in a manner depending on the drift rate, e.g. proportionally to it. The drift rate may be estimated, for example, from the duration of the period in which the sensor S3 is blinking (expressed in the number of belt cycles). If the blinking period is long, the drift rate is small, and vice versa. Alternatively, if the printing device was not operative between A and B for a longer period, it can be assumed that the condition change has taken place during the inoperative period, so that the number of cycles needed to cover sensor S3 since the resumption of operation can be used to obtain an estimate of the drift rate.

It is concluded from the detected drift direction (upward in the example of FIG. 4) whether the belt tension at the belt edge' is to be increased or decreased in order to counteract the detected drift (in the example of FIG. 4, it is to be increased). As a first “guess” of the new balance point, the steering end is now adjusted into a position half-way between the old setting Told and the high-tension-limit of the initial search interval, T₁₍₁₎. This first new adjustment setting is denoted as “T_{new(1)}” in FIG. 4. At the same time, the initial search interval is also halved, by dropping that half of the search interval which represents settings belonging to smaller tensions than T_{old} (since these smaller tensions are excluded by the fact that the belt drifts upwardly, not downwardly). The limits of the new search interval are T₁₍₂₎ and T₂₍₂₎.

The consequence of this adjustment is illustrated at C, on the left-hand side. In the example shown, it is assumed that the adjustment applied at B was excessive; hence, the belt now drifts in the reverse direction (downwardly in FIG. 4, depicted by a downward arrow). This drift will cause the sensor S3 to start blinking again, until it is completely uncovered. The activity described in connection with situation B above is not iteratively repeated. Since the tension has now to be lowered to counteract the drift, the tensioner is now adjusted to a further new adjustment setting, T_{new(2)}, which is half-way between the previous setting, T_{new(1)}, and the low-tension limit of the current search interval, T₂₍₂₎. Again, the search interval is halved, now by excluding the part corresponding to tensions higher than the previous setting; the new search interval's limits are denoted by T₁₍₃₎ and T₂₍₃₎.

If the first adjustment had not exceeded the balance point, the drift would have continued in the upward direction; naturally, the second adjustment would then have resulted in a setting half-way between the previous setting, T_{new(1)}, and the high-tension limit of the current search interval, T₁₍₂₎.

This procedure is iteratively repeated, as long as a belt drift is observed. In the example of FIG. 4, however, it is assumed that the belt exhibits no further drift after the second adjustment performed at C. This implies that the second setting T_{new(2)} is very close to the true balance point. Hence, the procedure is terminated here, and the printing device is now operated with the setting T_{new(2)} without further adjustments of the tensioner (illustrated at D). When another lateral movement of the belt is detected, the procedure starts again from the beginning, with a wide initial search interval, such as T₁₍₁₎ to T₂₍₁₎.

The feed-back control procedure described so far in connection with FIG. 4 has a differentiating character (i.e. it aims at stopping drift movements, but not at bringing the belt back to a nominal position). For example, if the tensioner setting after the first adjustment, T_{new(1)} had already come close to the balance point, no further drift would have been detected after the first adjustment, and the belt would therefore have remained in a state shown at B, i.e. with the sensor S3 covered.

These mainly differentiating characteristics may be overlaid by a functionality which brings the belt back to a center position, for example between print jobs, or, at a relatively low lateral-movement rate, during print jobs, so as to not cause deterioration in the image quality achieved.

FIG. 5 is a flow diagram illustrating the iterative balance-point search described in connection with FIG. 4 and, furthermore other activities which may be carried out in preparation of, or in addition to the balance-point search. At 71, the user is able to configure the belt-tracking system. For example, the user may specify, by means of a user interface to the controller, one or more of the items below:

(i) Maximum tension value allowed: this value represents Tₘₐₓ of FIG. 4;

(ii) Standard search interval/Amount of initial adjustment: this defines the initial search interval, T₁₍₁₎-T₂₍₁₎ of FIG. 4, in the case no drift-rate dependent-search interval is used;

(iii) Search-interval scale: this is a factor to increase (or decrease) the search interval, if calculated by the controller, e.g. based on the observed drift rate, to enhance the probability of finding the balance point;

(iv) Outside-range adjustment: this number defines a particularly high amount of adjustment to be applied if the belt edge moves outside a detection boundary (e.g. beyond S4 in FIG. 4) to bring the belt back into the detection range.

At 72, the belt-tracking system is started (for example, this may always happen upon starting the printing operation). At 73, the belt is re-centered, if it is detected that it is not within the sensor range (i.e. in the example of FIG. 4, if the belt edge is not between Si and S4). For example, the belt's re-centering is performed immediately after the start of the tracking system; it may also be performed between print jobs, etc.

At 74, the iterative-balance-point search described in connection with FIG. 4 is carried out. It includes activities 75 to 79 which form part of a loop through which the procedure may iteratively proceed, if required. At 75, the lateral-belt position is observed. At 76 it is ascertained whether the belt exhibits a lateral drift. If the answer is negative, the “balance point” is found; hence the iterative search is terminated, i.e. no (further) adjustment of the tensioner is performed, and a counter representing the number of iterations executed to find the balance point is reset at 80, so that the next iteration becomes what is called the “first iteration” below (in the case of a new iterative-balance-point search, e.g. due to a change of environmental conditions). However, if the answer is positive the activities 77-79 are performed. If the present iteration is the first iteration, the lateral-drift rate and the initial-search interval are determined at 77. At 78, the tensioner is adjusted in that direction in which the adjustment counteracts the observed drift; it is adjusted to the middle of the interval between the tensioner setting before the adjustment and the current search-interval boundary lying in the counteraction direction. A 79, the search interval is reduced to this interval; this is in preparation of the next iteration and causes the amount of adjustment to be halved from iteration to iteration (if there is no further iteration, this reduction of the search interval has no effect). The processing then returns to 75 to either perform the next iteration or terminate.

The disclosed embodiments enable very small single-sided belt-tension adjustments to be made, and thereby is able to keep high-strength belts, i.e. metal belts, under control.

All publications and existing systems mentioned in this specification are herein incorporated by reference.

Although certain methods and products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

1. A belt-tracking apparatus for a printing device, comprising:
a steering roller and a guiding roller;
a continuous belt encompassing the rollers;
a belt-steering mechanism arranged to counteract a lateral belt movement by adjusting the distance between one end of the steering roller and the corresponding end of the guiding roller by means of an actuator,
said actuator is movably mounted on a base structure and arranged to rotate a threaded control rod having two differentially pitched threaded sections,
wherein the first section cooperates with a corresponding thread of a base structure, and the second section cooperates with a corresponding thread of said end of the steering roller, so that a rotation of the control rod shifts said end of the steering roller relative to the corresponding end of the guiding roller, and the actuator relative to the base structure.

2. The belt-tracking apparatus of claim 1, wherein the pitch difference is such that the relative movement between said end of the steering roller and the base structure is less than between the actuator and the base structure.

3. The belt-tracking apparatus of claim 1, wherein a ratio between the pitches of the first and the second threaded section lies within a range from 1.1 to 1.5.

4. The belt-tracking apparatus of claim 1, wherein the actuator comprises an electric drive motor and a gear.

5. The belt-tracking apparatus of claim 1, wherein the actuator comprises a measuring device to measure the linear movement of the actuator with respect to the base structure and to generate a corresponding actuator displacement signal.

6. The belt-tracking apparatus of claim 1, further comprising a sensor arrangement arranged to sense a lateral belt displacement and to generate displacement signals indicative of it.

7. The belt-tracking apparatus of claim 6, wherein the sensor arrangement comprises at least two sensors arranged to generate displacement signals.

8. The belt-tracking apparatus of claim 6, further comprising a controller arranged to control the actuator based on the displacement signals.

9. The belt-tracking apparatus of claim 1, wherein the belt is a metal belt.

10. The belt-tracking apparatus of claim 1, wherein the belt is perforated and its inner side is connected to a vacuum source to suck a printing media onto the belt.

11. A printing device, comprising:
a conveying belt:
image-forming devices consecutively arranged across the conveying belt, wherein the conveying belt is arranged to convey a Print media Past the image-forming devices; and
a belt-tracking apparatus arranged to counteract a lateral drift of a conveying belt, the belt-tracking apparatus comprising:
an adjustable belt tensioner arranged to apply variable tension to one side of the belt;
an actuator arranged to adjust the belt tensioner;
a sensor arrangement arranged to observe the belt's lateral position;
a controller arranged, in response to a detection of a change of the belt's lateral position, to adjust the tensioner by an initial amount in an initial direction by means of the actuator; and to iteratively carry out the following activity, as long as changes of the belt's lateral position are detected: in response to a detection of a continued change of the belt's lateral position, further adjusting the tensioner in the same direction, or else, in response to a detection of a reversed change of the belt's lateral position, adjusting the tensioner in the other direction, wherein the amount of adjustment in the same or other direction is a predetermined fraction of the previous amount of adjustment.

12. A method of counteracting a lateral drift of a conveying belt in a printing device having image-forming devices consecutively arranged across the conveying belt by means of an adjustable belt tensioner applying variable tension to one side of the belt, comprising:
conveying, by the conveying belt, a print media past the image-forming devices; and
observing the belt's lateral position;
in response to a detection of a change of the belt's lateral position, adjusting the tensioner by an initial amount in an initial direction; and
iteratively carrying out the following activity, as long as changes of the belt's lateral position are detected:
in response to a detection of a continued change of the belt's lateral position, further adjusting the tensioner in the same direction, or else, in response to a detection of a reversed change of the belt's lateral position, adjusting the tensioner in the other direction, wherein the amount of adjustment in the same or other direction is a predetermined fraction of the previous amount of adjustment, consisting of a half of the previous amount of adiustment.

13. (canceled)

14. The method of claim 12, further comprising:
determining a rate of change of the belt's lateral position, based on the detection of a change of the belt's lateral position and the number of belt cycles needed for it to occur;
choosing the initial amount of adjustment in dependence of the rate of position change, wherein a higher rate of position change corresponds to a higher initial amount of adjustment.
